(19) United States
(12) Patent Application Publication
(10) Pub. No.: US 2021/0181900 A1
(43) Pub. Date: Jun. 17, 2021

(54) SYSTEM FOR A SCROLLING MODE INTERFACE IN A VEHICLE

(71) Applicants: DENSO International America, Inc., Southfield, MI (US); Denso Corporation, Kariya (JP)

(72) Inventor: Jeffrey TURK, South Lyon, MI (US)

(21) Appl. No.: 16/710,937

(22) Filed: Dec. 11, 2019

(51) Int. Cl. G06F 3/0482; G06F 3/0485; G06F 3/0484; G06F 3/0483

(52) U.S. Cl. CPC G06F 3/0482; G06F 3/0485; G06K 9/00838; G06F 3/0483; G06F 3/04847

(57) ABSTRACT

A user interface in a vehicle system includes a processor programmed to output a user interface screen that includes a list of one or more selectable items found in a plurality of pages associated with the user interface screen, wherein the user interface screen includes a header section including information located along a top portion of the user interface screen, and in response to a scrolling action initiated by a user and a vehicle speed above a vehicle speed threshold, hide the header section.

### TECHNICAL FIELD

The present disclosure relates to user interface screens that include lists.

### BACKGROUND

Scrolling through lists on a user interface screen may have its challenges in a vehicle setting. For example, a list may be several pages long and difficult to scroll through when a user is driving a vehicle. Thus, it may be distracting to a driver to scroll through the list. Furthermore, such distraction may increase when utilizing a touch panel that requires a user to focus their cognitive load on scrolling via fingers versus a multimedia system that utilizes a haptic interface or similar input interface. Additionally, it may be cumbersome to constantly scroll through a list.

### SUMMARY

According to one embodiment, a user interface in a vehicle system includes a display screen configured to display a first user interface screen that includes a list of one or more selectable items found in a plurality of pages associated with the user interface screen, and a processor in communication with the display screen. The processor is programmed to, in response to a scrolling action initiated by a user and a vehicle speed falling above the vehicle speed threshold, output a second user interface screen that includes a button section including a plurality of selectable buttons associated with the one or more selectable items.

According to a second embodiment, a vehicle system includes one or more vehicle sensors configured to identify a vehicle environment from vehicle environment data, a display screen configured to display a first user interface screen that includes a list of one or more selectable items found in a plurality of pages associated with the user interface screen, and a processor in communication with the display screen and the one or more vehicle sensors. The processor is programmed to, in response to a scrolling action initiated by a user and vehicle environment data indicating conditions regarding the vehicle environment, output a second user interface screen that includes a button section including a plurality of selectable buttons associated with the one or more selectable items.

According to a third embodiment, a user interface in a vehicle system includes a processor programmed to output a user interface screen that includes a list of one or more selectable items found in a plurality of pages associated with the user interface screen, wherein the user interface screen includes a header section including information located along a top portion of the user interface screen, and in response to a scrolling action initiated by a user and a vehicle speed above a vehicle speed threshold, hide the header section.

### BRIEF DESCRIPTION OF THE DRAWINGS

FIG. 1 illustrates a system overview of a vehicle computer system that includes navigation functionality.

FIG. 2 illustrates a user interface screen that includes a list of selectable options that displays an example of a transition according to an illustrative embodiment.

FIG. 3 illustrates a flowchart 300 for modifying a user interface screen with a list of selectable options based on a vehicle environment, according to an embodiment.

FIG. 4A illustrates an example flowchart 400 with a threshold as related to a vehicle speed.

FIG. 4B illustrates an example flowchart 410 of a threshold as related to a type of road that the vehicle is traveling on.

FIG. 4C illustrates an example flowchart 420 of a threshold as related to a number of selectable options on a list of a user interface.

FIG. 4D may be an example flowchart 430 of thresholds as related to weather condition near the vehicle.

FIG. 4E illustrates an example flowchart 440 of a threshold as related to a presence or absence of passengers in the vehicle.

FIG. 4F illustrates an example flowchart 450 of thresholds as related to traffic conditions.

FIG. 4G illustrates an example flowchart 460 of a threshold as related to time of day.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Scrolling through lists on a user interface screen may have its challenges in a vehicle setting. For example, a list may be several pages long and difficult to scroll through while a user is driving a vehicle. Thus, it may be distracting to a driver to scroll such a list. Furthermore, such distraction may increase when utilizing a touch panel that requires a user to focus their cognitive load on scrolling via fingers versus a multimedia system that utilizes a haptic interface or similar input interface. Additionally, it may be cumbersome to constantly scroll through a list, even while stationary as opposed to driving. Thus, it may be advantageous to provide an alternative user interface based on scenarios in the vehicle to allow the driver to quickly find items on the list in certain vehicle scenarios and situations.

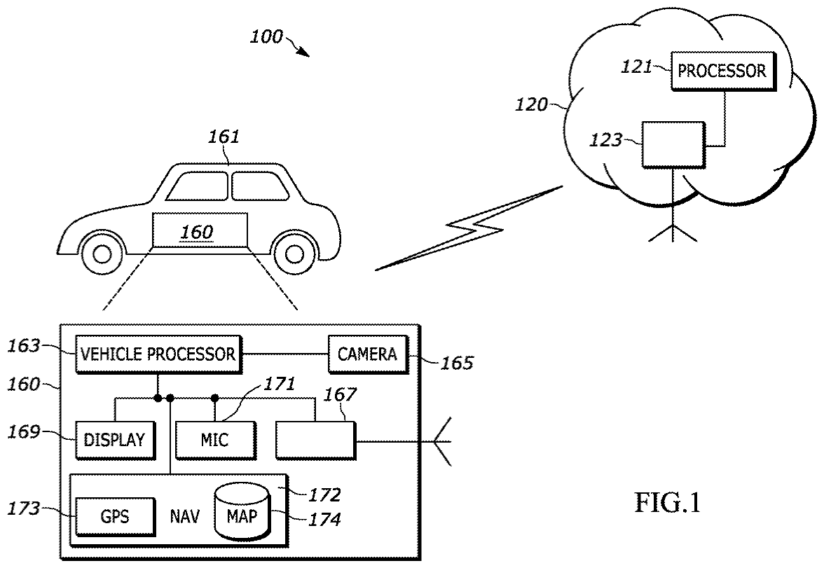

As shown in FIG. 1, a system 100 may include a remote server 120 (e.g., cloud) and a vehicle 161. The vehicle 161 may include any type of vehicle, such as a passenger vehicle, a commercial vehicle, motorcycle, sport utility vehicle, minivan, sedan, watercraft, off-road vehicle, etc. The vehicle 161 may be equipped with a transceiver 167 and a global positioning system (GPS) receiver 173 with the vehicle system 160. The GPS receiver 173 may receive signals transmitted from satellites for the GPS. The GPS receiver 173 may also be in communication with a gyroscope and/or a distance sensor. The GPS receiver 173 may detect a position coordinate and an altitude of the present position of the vehicle 161. If a gyroscope is utilized, the gyroscope may output a detection signal corresponding to an angular velocity of a rotational motion applied to the vehicle 161. The distance sensor may output a traveling distance of the vehicle 161. The vehicle 161 may include a vehicle speed sensor to measure the vehicle's speed. In some embodiments, the vehicle 161 may be equipped with a navigation controller that calculates the present position, direction, and velocity of the vehicle 161 based on the output signals from the GPS receiver 173, as well as the gyroscope and the distance sensor. Further, the present position may be calculated in various methods based on the output signal from the GPS receiver 173. For example, a single point positioning method or a relative positioning method may be used to calculate the present position of the vehicle 161. The vehicle 161 may utilize the transceiver 167 to communicate with the remote server 120, which may in turn share data with a mobile device associated with the customer or vehicle 161.

The vehicle 161 may include one or more displays 169 within the vehicle system 160. The display 169 may be a light-emitting diode (LED), liquid crystal display (LCD), organic light-emitting diode (OLED) screen (or other similar screens) with a touch screen display or utilize a haptic device. The display 169 may be located in, for example, an infotainment center of the vehicle 161. The infotainment center may be disposed at the center console of the vehicle 161 and displays menu buttons, such as audio selection, climate control, navigation, and other suitable operable systems available to passengers of the vehicle 161. In yet another example, the display 169 may include a head-up display (HUD) that may project images on a windshield of the vehicle 161. The image projected by the HUD may be information related to, for example, a travel direction, a vehicle speed, and lane markers.

The remote server 120 may include a data center controller 121. The data center controller 121 may include a microcomputer, which has a central processing unit (CPU), a read-only memory (ROM), a random access memory (RAM), an input/output (I/O) interface, and a bus line for coupling the CPU, the ROM, the RAM, and I/O interface. The data center controller 121 may include a communication device 123 (e.g., wireless transceiver, telematics device, stand-alone mobile device, or mobile device paired with a Bluetooth transceiver). The remote server 120 may communicate with the communication device 123 and the vehicle 161 using any wired or wireless communication protocol, including but not limited to Long-Term Evolution (LTE), WiFi, Bluetooth, WiGig, GPS, global navigation satellite system (GNSS), near field communication (NFC), or other telecommunication protocol. In an alternate embodiment, the vehicle 161 may also communicate wirelessly according to a known communication protocol such as, for example, the Dedicated Short Range Communication (DSRC) protocol, Ultra-Wide Band (UWB) protocol, or similar protocol implemented under standards, such as IEEE 802.11p, IEEE 1609, and/or SAE J2735. The remote server 120 may be wirelessly coupled to a network via the communication device 123 to allow for data communication to various devices. The remote server 120 may include more than one data center or server. The communication device 123 of the remote server 120 may perform data communication with a mobile device associated with the vehicle 161. The remote server 120 may include a database that includes data that may be relevant to the vehicle for traffic conditions or other information. For example, the remote server 120 may store real-time weather or traffic information to communicate to a vehicle system 160. Furthermore, the remote server 120 be receive updates and alerts to push to the vehicle 161 based on changing conditions or identification of extreme conditions (e.g., extreme weather conditions or traffic jams).

The vehicle 161 may include the vehicle system 160 that includes a vehicle processor 163, camera 165, transceiver 167, microphone 171, and other systems or sub-systems (e.g., navigation system 172). The navigation system 172 may be a portable terminal, such as a smart phone having a navigation function. The vehicle processor 163 may be utilized to send or collect data and other information from the camera 165, transceiver 167, GPS receiver 173, microphone 171, and other vehicle components. The transceiver 167 may be utilized to communicate with the mobile device of driver of the vehicle 161 via the remote server 120 (e.g., cloud) and associated telecommunications network. The transceiver 167 may be a telematics system or mobile device paired with the vehicle system 160 via the transceiver 167 (e.g., Bluetooth transceiver or any wired or wireless transceiver). The microphone 171 may be allowed to receive spoken dialogue commands from a user in one embodiment. The microphone 171 may be configured to receive speech from the driver (e.g., the owner of the vehicle or someone who may utilize the vehicle), or any other person. Additionally, the microphone 171 may allow a third party (e.g., another caller) to communicate with a remote person utilizing the microphone 171. The microphone 171 may be located in an interior cabin of the vehicle 161 (such as a passenger cabin) or may be located in an exterior location of the vehicle 161.

The vehicle system 160 may include a navigation system 172 that may be configured to generate geographic data for the vehicle 161, such as via communicating with one or more satellites orbiting Earth. The geographic data may indicate a current geographic location of the vehicle 161, such as by including current longitude and latitude coordinates of the vehicle 161. As some non-limiting examples, the navigation system 172 may include one or more of a GPS receiver, a Quazi-Zenith Satellite System (QZSS) receiver, a Russian Global Navigation Satellite System (GLONASS) receiver, a Galileo System (GSNN) receiver, an Indian Regional Navigation Satellite System (IRNSS) receiver, and an inertial navigation system (INS) receiver.

The navigation system 172 may communicate the geographic data to the vehicle processor 163, which may be configured to utilize the geographic data to determine the geographic location of the vehicle 161, and to correspondingly determine the geographic location of detected proximate objects. The vehicle 161 may also include a gyroscope or compass configured to indicate a current heading of the vehicle 161 which the vehicle processor 163 may combine with the geographic data to produce data indicating the current location and heading of the vehicle 161. Alternatively, the vehicle processor 163 may determine the heading of the vehicle 161 based on received geographic data indicating a changed position of the vehicle 161 over a short time span (e.g., one second), which suggests that the vehicle 161 is moving in a direction corresponding to the change in position.

The vehicle processor 163 may be configured to query map data 174 based on the geographic data to identify information about the travel infrastructure currently in use by the vehicle 161. In particular, the map data 174 may include detailed information about travel infrastructure in various geographic locations, such as road type (e.g., function class of the road, such as highway, city), road properties (e.g., one way, multi-lane, slope information, curvature information), detailed lane information (e.g., location, dimensions, restrictions such as no passing, turn-only, and traffic direction), and the locations and dimensions of curbs, sidewalks, traffic signals, traffic signs, and crosswalks relative to a road, traffic information, historical traffic information, as some non-limiting examples. Alternatively, the vehicle processor 163 may be configured to derive at least some of this information from proximity data generated by proximity sensors, such as via processing image data captured by camera 165 of the vehicle 161. The map data 174 may also overlay traffic information on a map that is retrieved from remote server 120 or another type of data source.

The vehicle may include a camera 165 that may also be an in-vehicle camera that may be mounted in the vehicle 161 to monitor occupants (e.g., a driver or passenger) within the vehicle cabin. The in-vehicle camera may be utilized to capture images of the vehicle cabin. For example, the in-vehicle camera may be utilized to obtain facial information from the driver or occupants or to analyze movements and facial expressions of the occupants. Furthermore, the camera 165 may utilize image recognition to identify a number of passengers in the vehicle. The in-vehicle camera may be a color camera, infrared camera, or time-of-flight camera. The in-vehicle camera may be mounted on a head rest, in the headliner, or located on a mobile device (e.g., tablet or mobile phone).

In one embodiment, the camera 165 may be mounted in a rear-view mirror of the vehicle 161. In other embodiments, the camera 165 may be located anywhere in the vehicle cabin or outside of the vehicle 161, such as the sides of the vehicle cabin or on top of the vehicle cabin. The camera 165 may also be facing out of the vehicle cabin through a windshield of the vehicle 161 to collect imagery data of the environment in front of the vehicle 161. The camera 165 may be utilized to collect information and data regarding the front of the vehicle 161 and for monitoring the conditions ahead and/or around the vehicle 161. The camera 165 may also be used for monitoring the conditions ahead of the vehicle 161 and correctly detecting the positions of lane markers as viewed from the position of the camera 165 and the presence/absence, for example, of lighting of the head lights of oncoming vehicles. For example, the camera 165 may be utilized to generate image data related to the vehicle's surrounding, lane markings ahead, and other types of object detection (e.g., pedestrians, vehicles, cyclists, light posts, parking spots, etc.). The vehicle 161 may also be equipped with a rear camera (not shown) for similar circumstances, such as monitoring the vehicle's environment around the rear proximity of the vehicle 161.

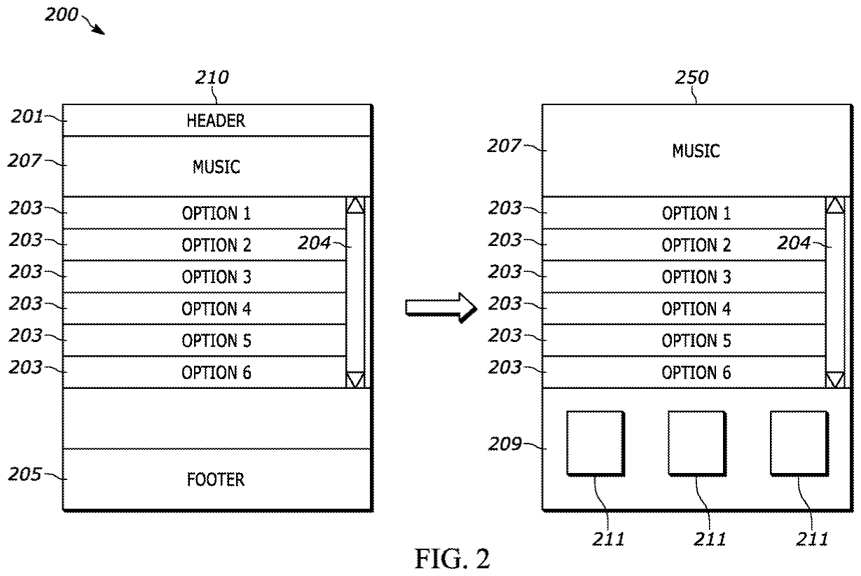

FIG. 2 may be an example of a user interface 200 that includes a list of selectable options that displays an example of a transition according to an illustrative embodiment. The user interface 200 may include a first user interface screen 210 (e.g., a default list screen) that has a header section 201 that includes information related to vehicle settings. The header section 201 may include information related to climate settings, navigation settings, music information, etc. The information found in the header section 201 may not be related to the list. For example, while the example first interface screen 210 may include information about music, the information in the header section 201 may be related to navigation, time, weather, or climate settings. The first user interface screen 210 may also include a footer section 205 that includes information related to vehicle settings. The footer section 205 may include information related to climate settings, navigation settings, music information, etc. The information found in the footer section 205 may not be related to the list. For example, while the example first user interface screen 210 may include information about music, the information in the footer section 205 may be related to navigation, time, weather, or climate settings. The first user interface screen 210 may also include a title section 207 that describes what the interface screen is related to. For example, the title section 207 may include information stating “Audio” for an audio interface screen, “Phone” for a mobile phone screen, “Navigation” for a navigation screen, etc.

The first user interface screen 210 may also include a list of selectable options 203. The list of selectable options 203 may change depending on the functionality utilized in the vehicle. For example, on a music or audio screen, the list of selectable options 203 may include track listings (e.g., artist listing, song listing, album listing, playlist listing, etc.), presets, channel information (e.g., AM or FM station listings, or satellite or internet radio listings, etc.), or other music related options. On a navigation screen, the list of selectable options 203 may include a listing of point of interests (POIs), address book listings, POI categories, etc. On a mobile phone or communication screen, the list of selectable options 203 may include a listing imported from an address book, recent calls, text messages, etc. The list of selectable options 203 may include multiple pages if several options are available. The list of selectable options 203 may be scrolled through utilizing a scroll bar 204, selecting a button, or via gestures (e.g., swiping up or down). One or more of the selectable options 203 may be selected based on a button via touching the option 203 or selecting the option 203 using another interface (e.g., haptic device).

The second user interface screen 250 may be an example of the interface screen in response to a scrolling action from a user. The scrolling action may refer to an action or gesture that may initiate a list or other portion of the interface to change pages or screens to show other options. The second user interface screen 250 may also include a list of selectable options 203, however, the interface may change based on conditions in the vehicle and the scrolling action initiated by the user. For example, the second user interface screen 250 may hide the header section 201 or footer section 205 of the screen once the scrolling action is initiated by the user and certain scenarios occur at the vehicle that change the vehicle environment. In another example, either the header section 201 or the footer section 205 may be hidden, rather than both sections 201, 205 hidden. In addition, the second user interface screen 250 may display a new “button bank” that is a button section 209 with buttons 211 related to the interface screen that is activated (e.g., audio screen, navigation screen, etc.) in response to scrolling and the vehicle environment. The buttons 211 may include one or more selectable buttons that are arranged in any order. The buttons 211 may be associated with the given user interface screen. For example, if the user is scrolling a list of music (e.g., albums, songs, artists, playlists) and is on an audio interface screen, the buttons 211 that are provided may be related to music functionality or to help with the music functionality. Thus, the buttons 211 may include a last played button (e.g., begin playing the last song), a voice recognition initiation button (e.g., activate a voice recognition session), a button to jump to the end of the list (e.g., scroll to the last page of the list), etc. If the user is scrolling a list on a navigation screen, the button section 209 may include navigation related buttons. For example, if the navigation screen includes a POI list that the user is scrolling through, the button section 209 may include buttons 211 related to “recently visited” POIs (e.g., display a list of the last six visited POIs), a voice recognition button, a “related categories” button (e.g., transition to a screen displaying related POI categories to select), etc. In yet another example, if the user is scrolling a contact list on the mobile phone screen, the button section 209 may include buttons 211 related to the phone screen. For example, the button section 209 may include buttons 211 related to “recent calls” (e.g., display a list of recent calls) or a voice recognition button.

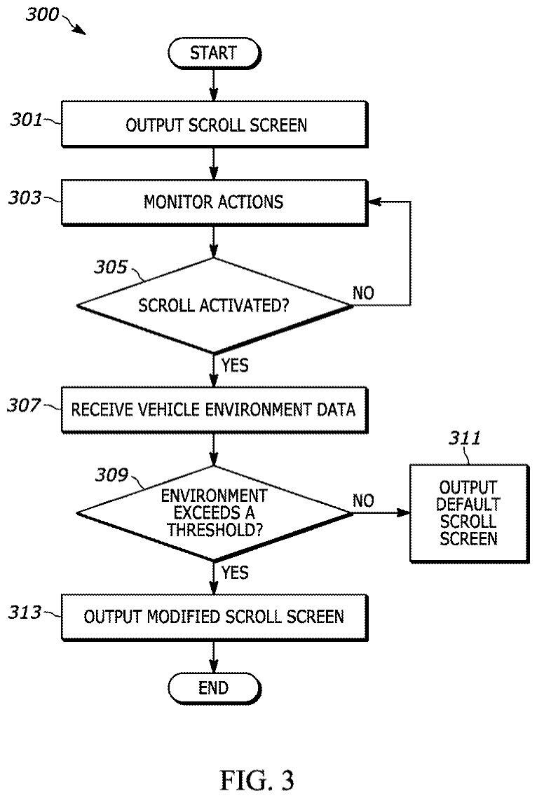

FIG. 3 illustrates a flowchart 300 as related to modifying a user interface screen for scrollable items based on various scenarios in the vehicle. At step 301, the system may output a scroll screen interface on a display. The scroll screen interface may be output on certain screens of the interface that includes several selectable options that require a list. For example, a music or audio screen may include track listings, a navigation screen may include a list of POIs, a communication screen may include an address book list, etc. At step 303, the system may monitor actions occurring on the interface screen. Thus, the system may monitor any input from the user. For example, the system may monitor for a touch screen selection of a button on the screen. In another example, the system may monitor for haptic input or any other type of input device utilized in the vehicle.

At decision 305, the system may determine whether a scrolling action is activated that requires the list to scroll up or down through the selectable options on the interface screen. The scrolling action may be operated based on input from the user. For example, the user may select a scroll bar (e.g., scroll bar 204) located alongside the list to move up or down a list. In other examples, the user may press a location on the scroll bar to either jump to a specific area of the list. In such an instance, if the user selects an area at the bottom of the scroll bar, the list may jump to the last selections. In the alternative, if the user selects an area the top of the scroll bar, the list may jump to the beginning of the selections. The user may also perform the scrolling action utilizing an input device such as turning a knob, haptic device, mouse, steering wheel switch or rocker, etc.

At step 307, the system may receive vehicle environment data. The vehicle environment data may be received from various vehicle sensors or off-board servers (e.g., remote server 120) in communication with the vehicle (e.g., vehicle 161) via wireless transceivers (e.g., communication device 123 and transceiver 167). The vehicle environment data may include data regarding the vehicle speed, weather, occupancy, road of travel, traffic conditions, content being displayed, time of day, etc. Thus, the vehicle environment data may be indicative of a current situation or scenario in the vehicle as perceived by the driver. The vehicle environment data may be collected from, but not limited to, vehicle speed sensors, remote servers, cameras, map data, GPS signal, vehicle clocks, etc.

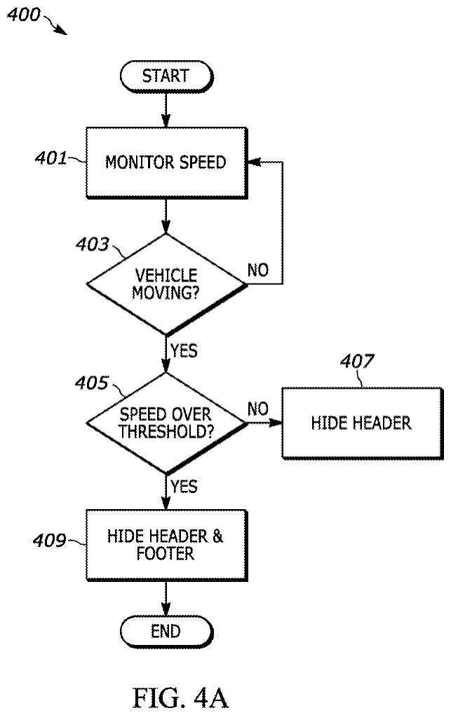

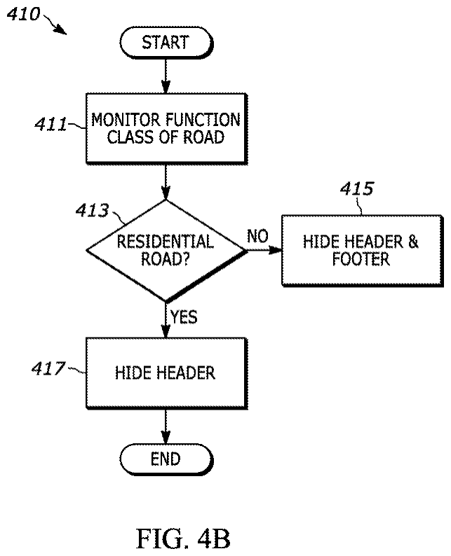

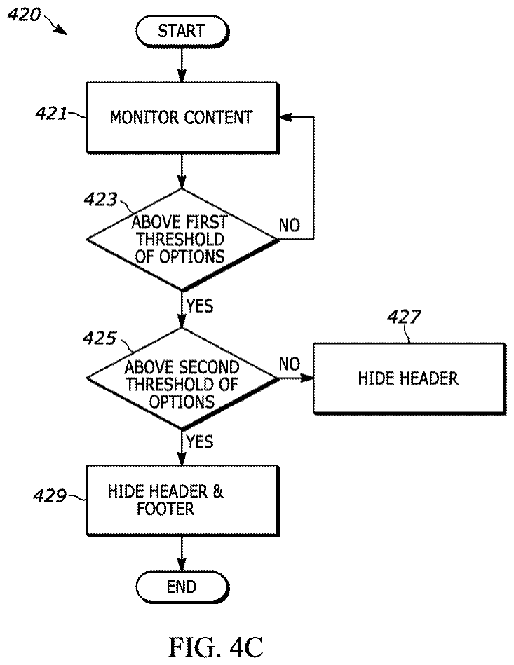

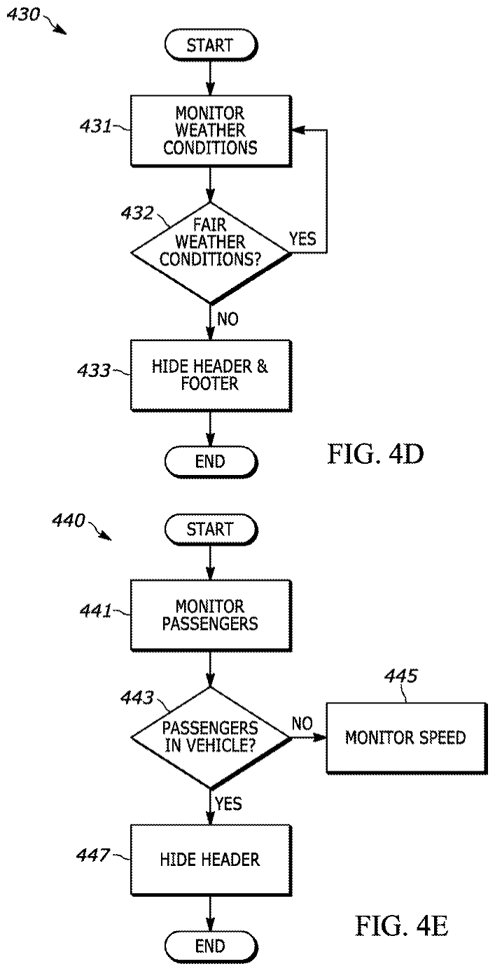

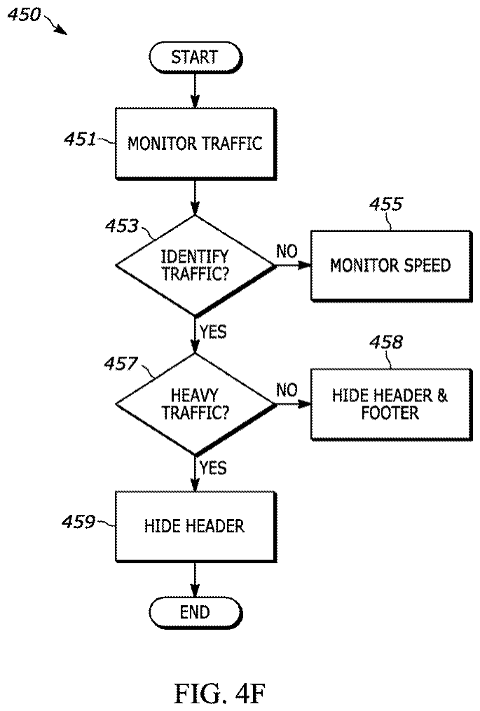

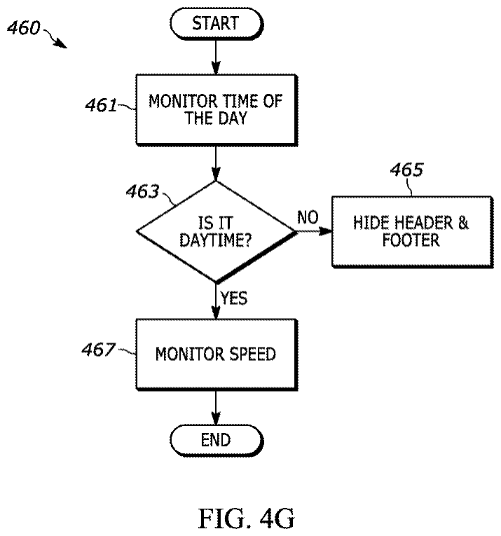

At decision 309, the system may determine whether the environment exceeds a threshold. The threshold may be utilized to determine if a change in the interface should occur for the scrolling action. The threshold may be a default setting that either can or cannot be modified by the user. For example, the interface may include a setting screen that allows the threshold for each type of scenario to be adjusted. For example, the scroll screen may change interfaces when scrolling occurs above 25 miles per hour (MPH), however, the user may be allowed to adjust the setting to either increase or decrease the speed that defines the threshold. Additional details regarding the various thresholds are explained, for example, with respect to FIGS. 4A-4G below.

At step 311, the system may output a default scroll screen (e.g., first user interface screen 210) when the vehicle environment data is below the threshold. Thus, the system may scroll according to previous designs and not modify the interface screen. Instead, the system may simply navigate through the list of selectable options without modifying the screen. In such scenarios, the scroll action may simply just move up and down the list, despite analyzing the vehicle environment data. In such scenarios, however, the vehicle environment data may indicate it is not necessary to modify the scroll list because the driver or user's cognitive load may not be high. Thus, a passenger may be able to navigate the list or the number of selectable options in the list in such a scenario. Thus, the threshold may be reflective in how the vehicle environment can affect task completion time or cognitive load to scroll through the list.

At step 313, the system may output a modified scroll screen (e.g., second user interface screen 250) when the vehicle environment data is above the threshold. The modified scroll screen may be output in response to the type of interface screen being displayed (e.g., music, mobile phone, navigation, etc.) and the vehicle environment data. Thus, the vehicle environment data may dictate how the specific interface screen is modified during a scrolling action. Such an example may be shown in the second user interface screen 250 of FIG. 2 and explained in FIGS. 4A-4G below.

FIG. 4A illustrates an example of flowchart 400 with a vehicle speed threshold as related to a vehicle speed. In one example, the system may determine what speed the vehicle is traveling at (e.g., vehicle speed). At step 401, the system may monitor the vehicle speed when the scrolling action is initiated. A vehicle speed sensor or other sensor may be in communication with the vehicle system to provide vehicle speeds. At decision 403, the system may determine whether the vehicle is moving or not. For example, if the system determines that the vehicle speed is at zero miles per hour (MPH) or parked, the system may not have any change to the scrolling user interface and simply continue to monitor the vehicle speed. However, if the system determines that the vehicle speed is moving, the system may determine if it has reached a vehicle speed threshold. At decision 405 the system may determine whether the vehicle speed has exceeded a vehicle speed threshold. If the system has determined that the vehicle speed is less than the vehicle speed threshold, the system may display an interface that may hide the header section but may leave the footer section remaining at step 407. In another embodiment, the system may operate inversely (e.g., hide the footer section but the header section remains). In one example, if the vehicle speed is between 1-25 MPH, the system may execute commands to hide the header section (e.g., the top portion of information), but may leave the footer section remaining. If the system has determined that the vehicle speed is greater than the vehicle speed threshold, the system may hide both the header section and the footer section at step 409. For example, if the vehicle speed is greater than 25 MPH (e.g., vehicle speed threshold is set at 25 MPH), the system may execute commands to hide both the header section and the footer section. In addition, more buttons may be shown at the bottom to help an operator access functionality easier given that the operator is driving the vehicle. The buttons may be buttons that are associated with the given user interface screen. For example, if the user is scrolling a track list of music (e.g., albums, songs, artists, playlists), the buttons that are provided may be related to music functionality or to help assist with the music functionality (e.g., a last played button, voice recognition initiation button, jump to end, etc.).

FIG. 4B illustrates an example flowchart 410 of a road type threshold as related to a type of road that the vehicle is traveling on. At step 411, the system may monitor the function class of a road that the vehicle is traveling on (e.g., local road or main roads, freeway, highway residential road, etc.) when a scrolling action is initiated. Location data and map data may be communicated to the vehicle system to provide such information. The system may choose to hide the header section or footer section individually or collectively based on the type of road utilized. Furthermore, the system may also display additional buttons that may provide options to help users navigate the scrolled list. At decision 413, the system may determine whether the vehicle is traveling on a residential road. If the vehicle is not traveling on a residential road, the system may hide both the header section and the footer section at step 415. In one example, the system determines that the vehicle is traveling on a freeway and the user initiates a scrolling action on an interface screen with a list, the system may hide the header section and the footer section. However, if the system determines that the vehicle is traveling on a residential road during the scrolling action, it may hide the header section only at step 417. For example, if the system determines that the vehicle is traveling on a residential road, the system may execute commands to hide the header section, but still display the footer section (or vice versa). In addition, more buttons may be shown at the bottom to help an operator access functionality easier given that the operator is driving the vehicle. In another embodiment, if the system determines that the vehicle is traveling on a highway, the system may execute commands to hide both the header section and the footer section. In addition, more buttons may be shown at the bottom to help an operator access functionality easier given that the operator is driving the vehicle. In yet another embodiment, if the system determines that the vehicle is traveling on a special road (e.g., bridge, mountainous road, off-mad, etc.), the system may execute commands to hide both the header section and the footer section. In addition, more buttons may be shown at the bottom to help an operator access functionality easier given that the operator is driving the vehicle.

FIG. 4C may be an example of a flowchart 420 with various selectable option thresholds as related to a number of selectable options on the list. In such a scenario, the system may execute commands to hide both the header section and the footer section depending on the number of selectable options in the list. In addition, more buttons may be shown at the bottom that provide options to help users navigate the scrolled list. In another example, the system may determine the number of selectable options in a list of the user interface and then determine whether to hide the header section or footer section, individually or collectively, based on number of options displayed. The system may monitor the number of selectable options in a list of the user interface at step 421. At decision 423, the system may determine if the interface screen is displaying a list greater than a first threshold of selectable options. The first threshold of selectable options may be whether or not the list requires multiple pages. If the system determines that the list is less than the first threshold of selectable options, it may continue to monitor the number of selectable options in the list. In one example, the system may determine that the interface screen is displaying a list that includes zero to five selectable options from the list. The system may not change the format of the interface screen upon a scrolling action by the user in such a scenario. However, if the system is greater than the first threshold, the system may then determine if the list is greater than a second threshold of options at decision 425. If the list is less than the second threshold of options, the system may hide the header section of the screen at step 427. For example, the system may determine that it is displaying a list with six to ten options and the system may hide the header section of the screen, but the footer section may remain. If the list is above the second threshold of options, the system may hide the header section and footer section of the screen at step 429. For example, the system may determine that it is displaying an interface with a list that includes greater than ten selectable options. In such an example, the system may hide both the header section and the footer section on the interface screen. In addition, additional buttons may be shown in the button section that provide options to help users navigate the scrolled list.

FIG. 4D may be an example flowchart 430 of a weather condition threshold as related to a weather condition near the vehicle. At step 431, the system may monitor weather conditions at the vehicle. In one example, the system may determine the local weather conditions near the vehicle based on weather data received from a remote server. The weather data may be sent to the vehicle via a transceiver and indicate whether the area has fair conditions (e.g., sunny, partly cloudy, etc.), precipitation (e.g., rain, snow, sleet, hail, etc.), or extreme weather conditions (e.g., tornado, severe thunderstorm, blizzard, etc.). At step 432, the system may determine whether fair weather conditions are present at the vehicle. If the fair weather conditions are present, the system may simply continue to monitor the weather at step 431. In one example, if the system determines that the weather conditions near the vehicle are fair conditions, the system may simply utilize the vehicle speed diagram as shown in FIG. 4A to monitor whether or not to update the user interface during a scrolling action. However, if fair weather conditions do not exist (e.g., precipitation or extreme weather conditions), the system may update the user interface upon a scrolling action. At step 433, the system may then hide the header section or footer section, individually or collectively, based on the weather data indicating precipitation or extreme weather exist. Furthermore, the system may also display additional buttons that may provide options to help users navigate the scrolled list as pertaining to the weather data. Or in another embodiment, the system may not change the format of the interface screen in response to a scrolling action initiated by the user. In another scenario, however, the system may determine that weather conditions include precipitation around the vehicle. In such a scenario, the system may hide the header section and footer section portion of the screen (or simply hide the header section or the footer section of the interface screen). In another scenario, the system may determine that vehicle is in an area experiencing extreme weather conditions. In such a scenario, the system may hide both the header section and the footer section. In addition, additional buttons may be shown at the bottom portion of the screen (or any other area) to help an operator access functionality easier given that the operator is experiencing extreme weather conditions.

FIG. 4E illustrates an example flowchart 440 of an occupant threshold as related to a presence or absence of passengers in the vehicle. At step 441, the system may monitor for the presence of passengers in the vehicle. In one example, the system may determine the presence or absence of passengers in the front of the vehicle. The system may work with various sensors to determine the presence or absence of passengers. For example, a camera may be utilized to identify a passenger sitting in the front seat. In another embodiment, a seat sensor may measure a weight to determine if a passenger is in the vehicle. At decision 443, the system may determine if any passengers are in the vehicle. If the system determines that the vehicle does not have any passengers during a scrolling action, the system may simply monitor the vehicle speed at 445 to determine whether or not to update the user interface. Thus, the system may simply utilize the vehicle speed diagram as shown in FIG. 4A to monitor whether or not to update the user interface during a scrolling action. However, if the system determines that there is a presence of a passenger in the vehicle, for example in the front passenger seat, the system may hide the header section of the interface screen at step 447. In another example, the system may not change the format of the interface screen in response to a scrolling action initiated by the user when passengers are present. In another example, additional buttons may be shown at the bottom portion of the screen (or any other area) to help an operator access functionality.

FIG. 4F may be an example of flowchart 450 of various traffic thresholds as related to traffic conditions around the vehicle. At step 451, the system may monitor traffic conditions at the vehicle. The system may monitor traffic conditions from off-board traffic data sent via transceiver or other communication device. The traffic data can indicate traffic flow, traffic incidents, and other traffic-related data. At decision 453, the system may determine whether traffic is present at the vehicle during initiation of a scrolling action. If the system determines that the vehicle is not present in traffic conditions during a scrolling action, the system may simply monitor the vehicle speed at 445 to determine whether or not to update the user interface. Thus, the system may simply utilize the vehicle speed diagram as shown in FIG. 4A to monitor whether or not to update the user interface during a scrolling action. However, if the system determines that there is traffic at the vehicle, the system may then determine whether the traffic is heavy traffic at decision 457. If the traffic is not heavy traffic (e.g., light traffic), the system may then hide both the header section and the footer section at step 458. In addition, additional buttons may be shown at the bottom portion of the screen (or any other area) to help an operator access functionality easier given that the traffic conditions. However, if the traffic is heavy traffic during the scrolling action, the system may hide the header section of the interface screen at step 459.

FIG. 4G may be an example flowchart 460 of a time threshold as related to a time of day. The system may then determine whether to hide the header section or footer section, individually or collectively, based on the time of day. Furthermore, the system may also display additional buttons that may provide options to help users navigate the scrolled list. At step 461, the system may monitor the time of day during a scrolling action. The system may include an on-board clock or be in communication with a clock (e.g., from the GPS receiver) to determine the time of day. At decision 463, the system may determine whether or not it is daytime for the vehicle during the scrolling action. At step 465, the system may determine that the time of day is not daytime and is thus nighttime (e.g., after dusk or a certain time in the evening) and then hide the header section and the footer section of the interface screen. In addition, the system may also display additional buttons that may provide options to help users navigate the scrolled list. At step 467, the system may determine that the time of day is daytime and the system may simply follow the speed threshold diagram that is shown at FIG. 4A, for example.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A user interface in a vehicle system, comprising:
a display screen configured to display a first user interface screen that includes a list of one or more selectable items found in a plurality of pages of the list associated with a user interface screen; and
a processor in communication with the display screen and programmed to:
in response to both a scrolling action initiated by a user and a vehicle speed being above a vehicle speed threshold, output a second user interface screen that includes a list and a button section including a plurality of selectable buttons associated with the one or more selectable items, wherein the plurality of selectable buttons are configured to at least activate a recent call, recent point-of-interest, or preset associated with a matching category of the list and wherein the plurality of selectable buttons were not displayed prior to the scrolling action and the vehicle speed being above the vehicle speed threshold.

2. The user interface of claim 1, wherein the first user interface screen includes a header section including information located along a top portion of the first user interface screen.

3. The user interface of claim 2, wherein the processor is further programmed to hide the header section in response to the scrolling action initiated by the user and the vehicle speed being above the vehicle speed threshold.

4. The user interface of claim 2, wherein the processor is further programmed to hide the header section in response to the scrolling action initiated by the user.

5. The user interface of claim 1, wherein the first user interface screen includes a footer section including information located along a bottom portion of the first user interface screen.

6. The user interface of claim 5, wherein the processor is further programmed to hide the footer section in response to the scrolling action initiated by the user.

7. The user interface of claim 5, wherein the first user interface screen includes a header section including information located along a top portion of the first user interface screen.

8. The user interface of claim 7, wherein the processor is further programmed to hide the header section in response to the scrolling action initiated by the user.

9. The user interface of claim 1, wherein the processor is further programmed to output a setting configured to disable output of the second user interface screen.

10. A vehicle system, comprising:
one or more vehicle sensors configured to identify a vehicle environment from vehicle environment data;
a display screen configured to display a first user interface screen that includes a list of one or more selectable items found in a plurality of pages associated with a user interface screen; and
a processor in communication with the display screen and the one or more vehicle sensors, wherein the processor is programmed to:
in response to bot a scrolling action initiated by a user and vehicle environment data indicating conditions regarding the vehicle environment, output a second user interface screen that includes a button section including a plurality of selectable buttons associated with the one or more selectable items, wherein the plurality of selectable buttons are configured to at least activate a shortcut associated with a matching category of the list, wherein the plurality of selectable buttons were not displayed prior to the scrolling action and the vehicle speed being above the vehicle speed threshold.

11. The vehicle system of claim 10, wherein the one or more vehicle sensors are further configured to identify a number of vehicle occupants.

12. The vehicle system of claim 11, wherein the processor is further programmed to in response to the number of vehicle occupants, output the second user interface screen.

13. The vehicle system of claim 10, wherein the processor is further programmed to output a setting configured to disable output of the second user interface screen.

14. The vehicle system of claim 10, wherein the vehicle environment data includes map data.

15. The vehicle system of claim 10, wherein the vehicle environment includes weather data.

16. A user interface in a vehicle system, comprising:
a processor programmed to:
output a user interface screen that includes a list of one or more selectable items found in a plurality of pages associated with the user interface screen, wherein the user interface screen includes a header section including information located along a top portion of the user interface screen; and
in response to both a scrolling action initiated by a user and a vehicle speed above a vehicle speed threshold, hide the header section, and output on the user interface screen a button section including a plurality of selectable buttons associated with the one or more selectable items, wherein the plurality of selectable buttons are configured to at least activate a recent call, recent point-of-interest, or preset associated with the list, wherein the plurality of selectable buttons were not displayed prior to the scrolling action and the vehicle speed being above the vehicle speed threshold.

17. The user interface of claim 16, wherein the processor is further programmed to, in response to the scrolling action and the vehicle speed above the vehicle speed threshold, output on the user interface screen a button section including a plurality of selectable buttons associated with actions related to the one or more selectable items.

18. The user interface of claim 16, wherein the processor is further programmed to output the user interface screen including a footer section including information located along a bottom portion of the user interface screen.

19. The user interface of claim 18, wherein the processor is further programmed to, in response to a scrolling action initiated by a user and the vehicle speed being above the vehicle speed threshold, hide the footer section.

20. (canceled)
